(19) United States
(12) Patent Application Publication
(10) Pub. No.: US 2007/0082149 A1
(43) Pub. Date: Apr. 12, 2007

(54) Method for producing a piece made of sintered amorphous silica, and mold and slurry used in this method

(76) Inventors: Cyrill Linnot, Aix-en-Provence (FR); Bernard Poullain, Paris (FR)

Correspondence Address: YOUNG & THOMPSON, 745 SOUTH 23RD STREET, 2ND FLOOR, ARLINGTON, VA, 22202, US

(21) Appl. No.: 10/567,489

(22) PCT Filed: Aug. 4, 2004
(86) PCT No.: PCT/FR04/02084

§ 371 Date: Sep. 25, 2006

(30) Foreign Application Priority Data
Aug. 7, 2003 (FR) 03/09732

(51) Int. Cl. B28B 11/00; B29C 33/56; C03B 32/00; F16L 9/10

(52) U.S. Cl. 428/34.4; 65/111; 249/114.1

(57) ABSTRACT

The method for producing a piece made of sintered silica includes the following steps: a) casting a slurry, which is based on an amorphous silica powder and on a liquid, between the inner (14) and outer (12) parts of a mold (10) in such a manner as to delimit a wall (38) of the piece (40); b) evacuating, at least in part, the liquid; c) removing the piece from the mold whereby obtaining a green piece; d) additionally drying the green piece, and; e) sintering the green piece. This method is characterized in that in step b), the solvent is evacuated through a single inner (14) and outer (12) part of the mold (10) in at least one are delimiting a useful portion of the wall (38), the impermeable part having a deformable lining (30).

The invention relates to a method of fabricating a sintered amorphous silica part, and a mold and a slurry used in that method.

By way of preliminaries, the following definitions are given.

The expression “slurry” refers to a substance formed by a suspension of particles in a liquid, generally water with or without additives such as dispersants, deflocculating agents, polymers, etc.

In particular, the expression “silica slurry” refers to a slurry the particles whereof consist essentially of silica. Unless otherwise indicated, the term “slurry” when employed in this document refers to a silica slurry.

The expression “green part” refers to the part obtained after removal from the mold and before sintering, which has been at least partially dried to a sufficient extent to ensure the integrity of the part and to maintain its geometry when handling it after its removal from the mold.

The expression “preform” refers to the green part before it is removed from the mold.

The sintered silica part may in particular be a crucible used to grow crystalline silicon, in particular polycrystalline silicon used in the semiconductor industry, for example, or to produce wafers for photovoltalc cells constituting solar panels.

For the above applications, the silica used or one of the silicas included in the mixture of powders that constitute the dry portion of the slurry must be particularly pure (in particular, one of the silicas may be synthetic), and the process must not introduce impurities exceeding the specifications imposed by the clients. In particular, the interior surface of the crucible in contact with the silicon must remain pure during the crystallization cycle.

Many types of fabrication process for producing silica crucibles or other parts are known in the art.

FR-A-2 726 820, for example, describes one prior art method of fusing quartz sand using an electrical arc. The raw material is introduced into a rotating hollow mold and centrifugal force distributes the quartz sand over the walls of the mold and holds it there. Heating by an electrical arc then fabricates the crucible by fusing the quartz sand into amorphous silica.

With a method of the above type, the shape of the crucible is necessarily that of a body of revolution. In particular, it is impossible to produce a crucible of cubical shape or having a wall of constant thickness.

Sol-gel and electrophoretic deposition fabrication methods are also known in the art, for example that described in US 2002/152768. However, the water content of the preforms is very high in these methods. This results in major shrinkage during drying, typically in excess of 5%. The crucibles must therefore be of small size, typically less than 300-400 mm.

Moreover, the cost of such crucibles is generally high, in particular because of the cost of the precursors and the number and length of the process steps required.

Fabrication methods that entail casting a slurry in a plaster mold, drying and sintering are also known in the art. While the slurry is drying, the plaster absorbs some of the water from the slurry, leaving in the mold only the dry material and the water that constitute the green part.

The green part obtained with these methods is very fragile and difficult to handle. It is therefore difficult to produce parts having both large dimensions and thin walls of constant section or having very small relief angles.

Such parts are very difficult to remove from the mold without damaging them and to manipulate afterwards. Silica slurries do not have the plastic character of slurries containing clay, for example. The green parts are therefore extremely sensitive to any mechanical stress. Stresses create defects such as cracks, distortion, marks, etc.

Stresses may be induced by drying when in or out of the mold, for example, and may also be exerted by the mold, one of its components, an accessory or an operator during fabrication operations, in particular during removal from the mold. These stresses may be induced in the material of the green part or exerted directly on the green part, for example by rubbing during removal from the mold or some other fabrication operation, or by impact, however slight.

Moreover, the constituents of the plaster pollute the part, in particular alkali and alkaline earth elements such as calcium and sodium.

In the case of fabrication methods entailing casting a slurry, drying and sintering, U.S. Pat. No. 5,360,773 proposes to favor shaping and sintering by using for fabricating the slurry a silica-based powder having a specific particle size distribution and a high specific surface area.

However, preparing the powders described in the above document necessitates a plurality of costly process steps. Moreover, silica particles being highly hydrophilic, the greater their specific surface area, the greater the water content of the slurry must be to enable it to be cast in the mold. Selecting particles having a high specific surface area therefore leads to high dimensional shrinkage during drying that induces risks of deformation and residual stresses. Moreover, the high dimensional shrinkage makes it difficult to comply with close dimensional tolerances.

Recent approaches attempt to solve this problem, such as that described in WO 0117902, in which the particle size distribution of the silica particles must be bimodal and the proportion by weight of liquid in the slurry must be reduced to less than 20%.

Reducing the quantity of liquid (usually water) reduces dimensional shrinkage but does not eliminate it completely.

Shrinkage is also linked to the compactness of the green part. A bimodal distribution does not achieve an optimum green compactness. The green densities obtained according to WO 0117902 are typically of the order of 1.6 and, according to the results set out in WO 0117902, a temperature of more than 1350° C. is required to obtain a density exceeding 1.8.

Shrinkage of the material creates mechanical stresses in the preform that is being formed during curing of the slurry in the mold and thereafter in the green part during drying. There is therefore a high risk of the part breaking, especially if it is large.

Thus a bimodal distribution is to be recommended only in the case of small parts and/or parts having a thin wall and/or a low density.

There is therefore a need for a sintered silica part fabrication process that is simple, can produce large parts, of any shape, where appropriate having thin walls, of low porosity, of high density when green, typically exceeding 1.9, and with substantially no shrinkage during drying, and that preserves the purity of the powders employed in the slurry.

The object of the present invention is to meet that need.

According to the invention, that object is achieved by a method of fabricating a sintered silica part, comprising the following steps:

a) casting a slurry based on amorphous silica powder and a liquid between an interior portion (14) and an exterior portion (12) of a mold (10) to delimit a wall (38) of said part (40),

b) at least partially evacuating said liquid to obtain a preform,

c) removing said preform from the mold to obtain a green part,

d) further drying said green part,

e) sintering said green part.

This fabrication method is noteworthy in that, in the step b), in at least one area delimiting a usable portion of said wall, said liquid is evacuated through one only of said interior portion and said exterior portion of said mold, called the “permeable portion”, the other portion being called the “impermeable portion”.

As will emerge in more detail in the remainder of the description, the sintered part fabricated in the above manner has the advantage of a very high compactness (density greater than or equal to 1.9 g/cm³). Moreover, the impermeable portion prevents chemical pollution of the silica by contact.

The preform and the sintered part can advantageously be of any shape, provided that it remains possible to remove them from the mold. In particular, the preform may be cubical, cylindrical, and more generally have any container or crucible shape.

The profile in cross section of a wall of the mold advantageously reveals a very homogeneous porosity, and, on the side in contact with the impermeable portion of the mold, a surface state remarkably similar to that of the impermeable face of the mold.

The method of the invention has the advantage that it can be used to fabricate thin parts of very regular thickness (typically less than 20 mm), of large size (typically more than 500 mm), having very small relief angles (typically less than 1°), of high purity, of low cost and not necessitating any treatment subsequent to sintering.

The method of the invention preferably has the following further features:
Prior to the step e), a coating material, preferably a precursor of silicon nitride (Si₃N₄), is applied to said green part.
During the step b), feeding of said mold with slurry continues to compensate the evacuation of said liquid. The method of the invention allows slow evacuation of the liquid, and thus has the advantage that it favors the compensation of this evacuation by the additional slurry.
During the step b), to encourage the elimination of bubbles in said slurry, a reduced pressure may be maintained before casting of the slurry and/or, independently, in said mold. This advantageously reduces the porosity of the preform. Similarly, to eliminate bubbles, the slurry may be exposed to a partial vacuum just before it is cast.

The invention also provides a green part fabricated by the steps a) to c) of a method according to the invention. This green part is noteworthy in that it has a three-point bending strength, as measured by the test described in the examples, from 2 to 10 MPa.

The invention also relates to a sintered silica part fabricated by the method according to the invention, in particular a crucible, that is noteworthy in that it has a three-point bending strength from 16 to 30 Mpa and preferably a density from 1.6 to 2.2 g/cm³.

The invention further relates to the use of this amorphous silica powder crucible, yielding a silica purity greater than 99.5%, to fabricate polycrystalline silicon ingots.

The invention further provides a mold for fabricating a silica-based preform intended to be sintered, adapted to receive a slurry based on amorphous silica particles and a liquid, having an interior portion and an exterior portion adapted to delimit a wall of said preform. This mold is noteworthy in that, at least in an area delimiting a usable portion of said wall, only one of said interior portion and exterior portion is permeable to said liquid.

The above mold is preferably used in the method of the invention.

The above mold preferably has the following additional features:
In said area, the distance between said interior portion and said exterior portion is substantially constant, preferably less than 10 cm, more preferably less than 5 cm.
Said permeable portion is made of a material absorbing said liquid, preferably of plaster or a material absorbing said liquid in a similar manner to plaster.
In at least one area delimiting a usable portion of said wall, at least one of said interior and exterior portions is deformable. This deformable portion has the advantage that it minimizes residual stresses in the preform and distortion thereof as well as those to which the preform is subjected during its formation in adapting its shape because of the effect of the stresses exerted by the material of the preform during the step b).

The deformable portion nevertheless has sufficient inherent stiffness to be able to delimit one wall of the preform when the slurry is introduced into the mold. Unlike the mold described in DE 101 30 186, no external pressure is necessary to confer this stiffness on the mold. The deformable portion may thereafter be peeled off the preform, as described below, during the step c) of removing it from the mold, thereby avoiding subjecting the preform, which is easily damaged at this stage, to impact or rubbing.
Said portion that is not permeable to said liquid, facing said permeable portion, includes a liner deformable as a result of a modification of the dimensions of said preform during its fabrication. The flexibility of the liner has the advantage of preventing breakages during the fabrication of the preform, the liner remaining adjacent the slurry during the shrinkage resulting from drying.
Said liner is conformed to be removed or “peeled” toward the interior of said preform avoiding all contact with said preform. The flexibility of the liner has the advantage of preventing rubbing and other mechanical stresses during removal of the mold.
Said liner is preferably sufficiently deformable to allow forcible passage of a protruberance of said preform having a height less than or equal to 1.1 times the thickness of said liner during the removal of said preform from the mold. A crucible-shape preform therefore has the advantage of being able to carry a raised marking or pattern on its surface in contact with the liner, for example, or can be flared toward the bottom of the crucible.
Said liner is made of a material that is inert with respect to said slurry, in particular chemically inert. This feature has the advantage of avoiding diffusion of the material from the impermeable portion toward the preform. This prevents physical and chemical contamination of the preform, for example by alkali and alkaline earth compounds. This feature also prevents any chemical modification of the preform resulting from its contact with the liner.
Said liner, preferably made of silicone or a cellular material, does not adhere to said preform or may be unstuck from said preform by deformation of said liner during removal from the mold, in particular by injecting air between said liner and said preform. Thus no mold release agent is needed between the liner and the preform. As will emerge in more detail in the remainder of the description, a layer of coating material may be applied to the preform in this way after its removal from the mold.
Said liner includes air injection holes. The injected air has the advantage of facilitating removal of the preform from the mold by encouraging unsticking of the liner and sliding thereof on the preform.
Said portion impermeable to said liquid includes a support of said liner. During removal of the preform from the mold, said support is preferably removed without taking said liner with it, thereby avoiding any rubbing on the preform, after which said liner is peeled off and the preform removed from the mold. This has the advantage of preventing the preform from breaking or from being damaged.

The invention further relates to a slurry including a powder containing more than 99.5% amorphous silica mixed with a liquid, preferably water with or without additives, that is noteworthy in that it includes more than 85% of dry materials and has a viscosity from 1 to 30 Poises at the time it is cast in a mold.

The silica powder or each of the powders that may form part of the final powder mixture preferably has a specific surface area from 0.01 to 20 m²/g.

The final particle size distribution of the powder, where applicable obtained by mixing, incorporated in the liquid to produce the slurry, is preferably as close as possible to the Füller-Bolomey theoretical distribution.

A slurry of the above kind has the advantage of achieving a highly compacted preform, typically with a density exceeding 1.9, in particular when it is used with the method of the invention.

The invention further relates to the use of a slurry of the invention in a method of fabricating a green part intended to be sintered, said method including a step of casting under pressure.

Other features and advantages of the present invention sill become apparent on reading the following description and examining the appended drawings, in which:

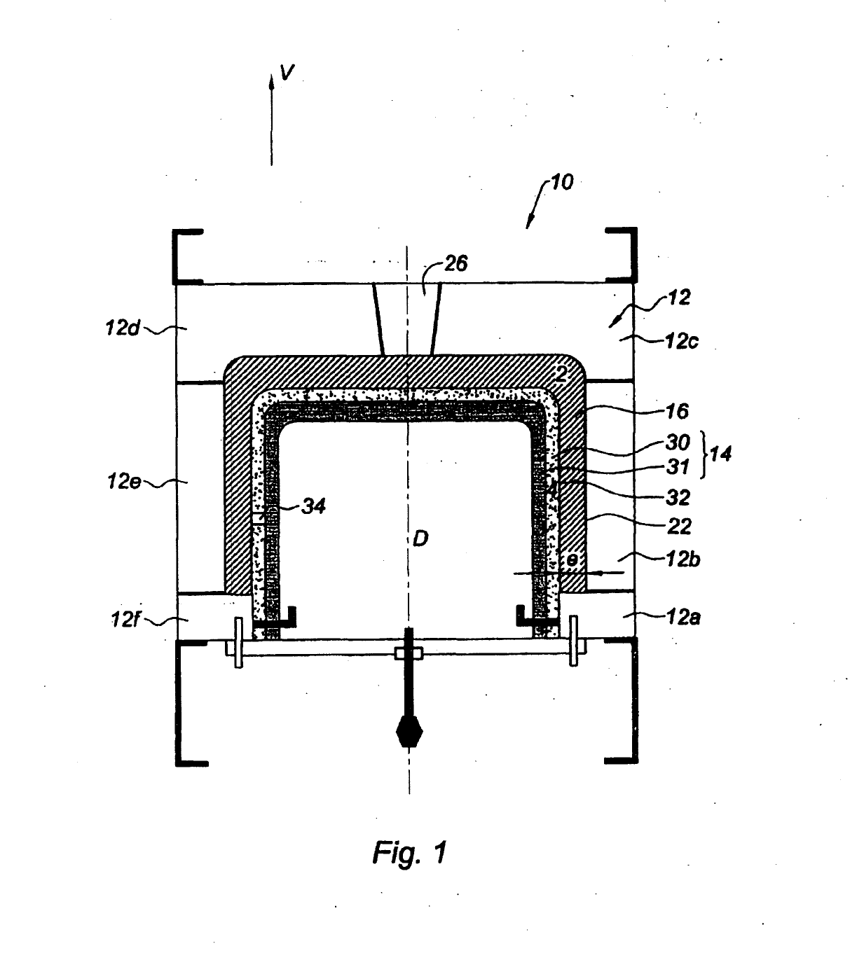

FIG. 1 shows a mold of the invention in cross section,

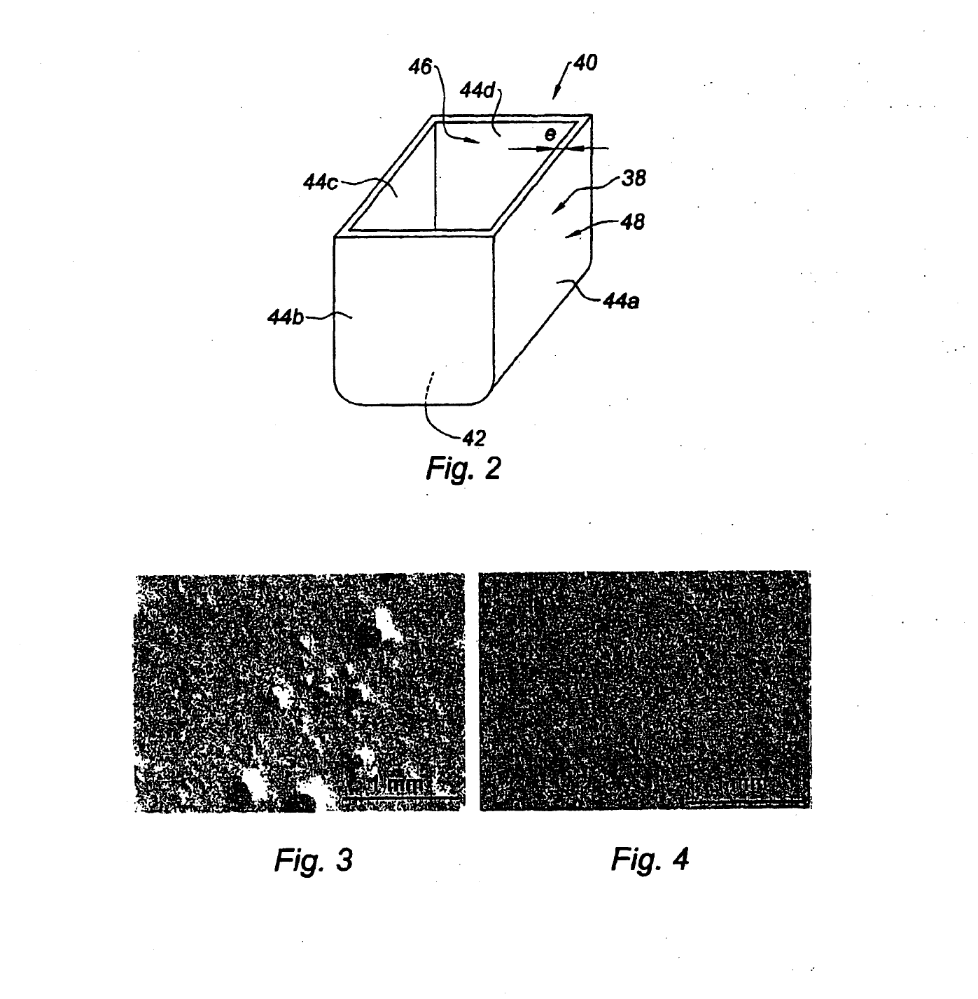

FIG. 2 shows a crucible fabricated by means of the mold shown in FIG. 1,

FIGS. 3 and 4 are photographs of sections of green parts cast with slurries according to the prior art and according to the invention, respectively,

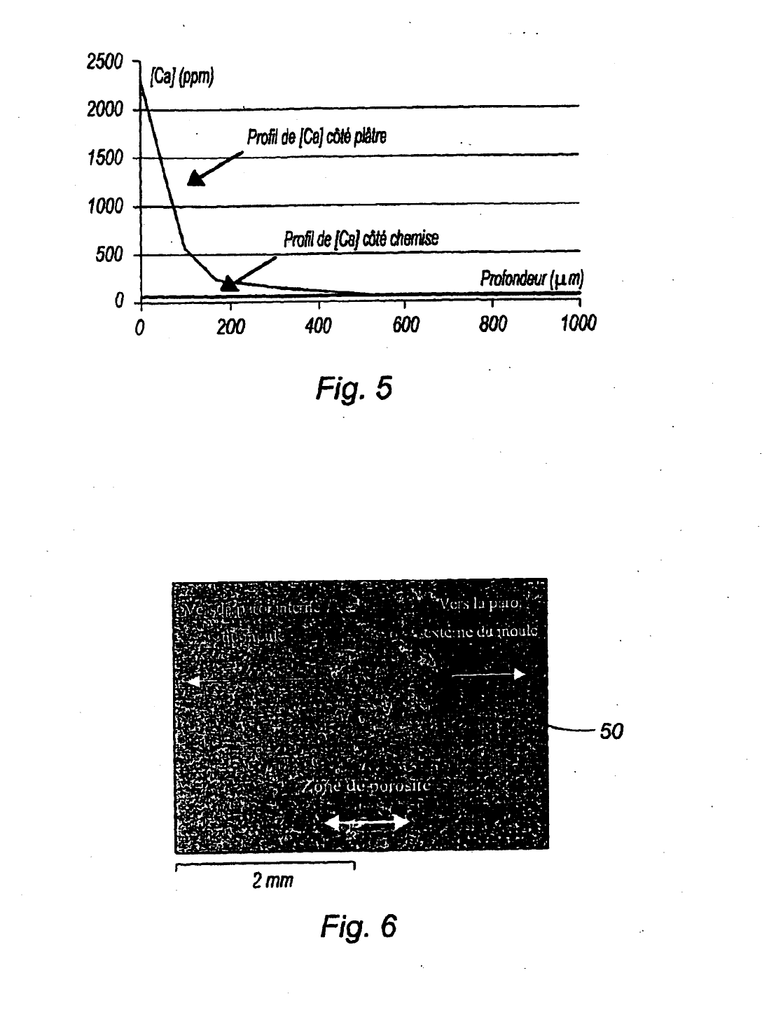

FIG. 5 shows the transverse profile of the concentration of calcium (Ca) in the wall of the FIG. 2 crucible, and

FIG. 6 is a scanning electron microscope photograph of a cross section of the wall of a prior art sintered part.

The sintered part of the invention has a shape and dimensions that are substantially identical to those of the green part used for its fabrication. The reference numbers used in FIG. 2 to designate portions of a crucible of the invention are therefore also used to designate the corresponding portions of the green part and of the preform from which the crucible is obtained.

FIG. 1 shows a mold of the invention used to produce the examples described hereinafter.

The mold 10 has an exterior portion 12, also called the “female portion”, and an interior portion 14, also called the “male portion” or “Internal core”. The interior portion 14 is inserted into the exterior portion 12 to define a molding volume 16 intended to receive slurry based on amorphous silica. The molding volume 16 of the mold 10 shown in FIG. 1 has the shape of an inverted crucible. The upward-pointing arrow V defines the vertical axis.

The exterior portion 12 has a porous interior face 22, for example of plaster, through which liquid may be evacuated from the molding volume 16. It is pierced by an upper opening 26 through which slurry may be introduced, by gravity, into the molding volume 16. The exterior portion 12 preferably includes an assembly of blocks 12a-12f that can be dismantled to release the preform with the minimum stress.

The interior portion 14 includes a liner 30 and a liner support 31.

The liner 30, made of silicone, for example, or of a cellular foam type material, has an exterior face 32 that is intended to be in contact with the slurry and is impermeable to the liquid. The liner 30 is preferably flexible and does not stick much if at all to the preform.

The term “flexible” means “having sufficient flexibility to accompany dimensional evolution of the part being formed inside the mold 10”. This flexibility is adapted by the choice of the nature of the material and of the thickness of the liner. The strength to guarantee the required shape is provided by the support 31.

The flexibility of the liner 30 has the advantage that it protects the part being formed and the preform from external impact. In particular, the liner 30 may be left temporarily on the preform after moving the support 31 away in order to protect it during its manipulation. The flexibility of the liner 30 is preferably sufficient for it to be able to deform, without breaking or damaging the preform, when it is forced over an additional thickness of the preform. For example, the deformation may result from passing over a protruberance on the preform oriented perpendicularly to the direction D of removal from the mold. The protruberance may be a raised letter, for example, formed on the interior surface of the preform in contact with the exterior face 32 of the liner 30 during molding.

The flexibility of the liner 30 is preferably sufficient for it to be “peeled off”, i.e. removed from the preform little by little, preferably by folding it back upon itself. This has the advantage that the interior portion 14 can be removed progressively by peeling off the liner 30, the portions of the liner 30 no longer in contact with the preform being folded toward the interior of the preform. Thus the preform can be removed from the mold without rubbing on the liner 30, which reduces the risk of breaking the preform.

The adhesion of the liner 30 to the preform is preferably sufficiently weak for the liner 30 to be removed from the preform, without tearing, by applying traction tending to separate it from the preform. In particular, materials having no physico-chemical affinity with the constituents of the slurry are preferred. The adhesion is preferably sufficiently weak that injecting air at a low pressure, typically from 1 to 5 atmospheres, between the exterior face 32 and the preform is sufficient to unstick the liner 30 after moving away the support 31. Holes 34 for injecting air are preferably formed in the liner 30 for this purpose.

FIG. 1 shows the position of these holes by way of example. Other locations adapted to the geometry of the part may be preferred.

The liner 30 is preferably inert in relation to the slurry, i.e. it does not react chemically with the slurry and the chemical elements that constitute it do not diffuse into the slurry.

The liner support 31 is designed to support the liner 30 and to prevent the slurry causing it to collapse before the latter has set. The support 31 is preferably made from a rigid material, for example metal. It is also preferable if the liner 30 is not stuck to the support 31, in order for the latter to be removable independently of the liner 30.

The molding volume 16 is delimited by the porous interior face 22 and the impermeable external face 32. The distance between the interior face 22 and the exterior face 32 is preferably less than 10 cm, more preferably less than 5 cm, in particular less than 25 mm.

This distance defines the thickness “e” of a wall 38 of a crucible 40, as shown in FIG. 2. The wall 38, of complementary shape to that of the molding volume 16, has a bottom 42 and four lateral walls 44a-44d. The wall 38 has an interior surface 46 intended to be in contact with the fabricated polycrystalline silicon, called the “contact surface”, and an exterior surface 48 substantially parallel to the interior surface 46.

According to the invention, in the areas of the mold 10 in which are formed the usable portions of the wall 38, i.e. the portions of the wall 38 having a contact surface, only one of the exterior and interior portions of the mold 10 is permeable to the liquid.

The slurry of the invention introduced into the molding volume 16 preferably includes a powder containing more than 99.5% amorphous silica mixed with a liquid, preferably water. According to the invention, the slurry contains more than 85% of dry materials and has a viscosity from 1 to 30 Poises when it is cast in a mold.

In the present description, the term “powder” refers to a powder or a mixture of powders.

The viscosity must enable a liter of slurry to flow under its own weight through a 23 mm calibrated orifice in less than 1 minute and in more than 5 seconds. This has the advantage that it allows air bubbles trapped when filling the mold to be evacuated naturally. The preform then has a high compactness and the wall 38 of the crucible 40 is then advantageously free of residual bubbles.

The very low viscosity of the slurry of the invention at the time of casting enables parts of small and constant thickness to be produced. It is possible to cast articles having dimensions greater than 700 mm, with vertical walls less than 20 mm or even 10 mm thick. The measured viscosity varies from 1 to 30 Poises.

The above viscosity is measured at 20° C. in climate-controlled surroundings using a Rhéolab Physica LM/MC rheometer in a 44 mm diameter tank 157 mm high with a paddle with two blades 25 mm wide, 80 mm high and 2 mm thick (“Z2 DIN” type mobile) completely immersed in the slurry to be characterized.

The measurement is carried out using the manufacturers software by imposing the rotation speed of the mobile and measuring the stress exerted during a cycle of 180 seconds. The cycle comprises a phase in which the shear rate is increased from 0 to 150 s⁻¹ in 60 seconds, a plateau of 60 seconds at 150 s⁻¹, followed by a phase in which the shear rate is reduced from 150 s⁻¹ to 0.

The viscosity is measured at the outlet of the plateau when the rotation speed of the mobile is constant. The viscosity is then calculated from the formula η=τ/D where η is the viscosity, τ is the measured shear stress and D is the imposed shear rate.

The required viscosity of the slurry is obtained by initial metering of the constituents of the slurry, checking just before casting, and adjusting the water content if necessary.

The preparation of the slurry of the invention has the advantage of minimizing shrinkage of the part during drying and sintering. This achieves excellent dimensional control.

Said amorphous silica powder or each of its constituent powders preferably has a specific surface area from 0.01 to 20 m²/g.

The powder based on amorphous silica preferably has a particle size distribution that conforms to the Füller-Bolomey law.

The Füller-Bolomey theory simulates an ideal distribution of grains given the diameter (dₘₐₓ) of the largest grains of the powder or of the mixture of powders and that (dₘᵢₙ) of the smallest grains.

The cumulative percentage (y_{d}) of grains of size less than a diameter d can then be calculated from the formula:

$${y}_{d} = {ad}^{\frac{1}{5}} + b where a = \frac{100}{{d}_{max}^{\frac{1}{5}} - {d}_{min}^{\frac{1}{5}}} and b = - {ad}_{min}^{\frac{1}{5}}$$

If y_{d exp} is the cumulative percentage by weight of the grains of the experimental mixture with a diameter less than d and y_{d Füller-Bolomey} is the cumulative percentage by weight of the grains of the theoretical mixture of diameter less than d, then an index of compactness (I) may be defined as follows:

$$I = {\sum }_{{d}_{min}}^{{d}_{max}} {( {y}_{d exp} - {y}_{d Füller - Bolomey} )}^{2}$$

The measurement points are 0.1 μm apart if d<1 μm, 1 μm apart if d<10 μm, 10 μm apart if d<100 μm, and 100 μm apart if d<1000 μm.

The required Index I is therefore the lowest possible Index. In this case, the experimental curve is as close as possible to the Füller-Bolomey model. The index is advantageously less than 500 and even more advantageously less than 100.

Of course, other optimum theoretical distribution models may be used to obtain powders achieving a satisfactory compactness that falls into the particle size distribution region defined above.

One or more of the silica powders of the mixture may be synthetic silica, i.e. silica synthesized from organic or mineral chemical precursors, rather than obtained by fusion of refined or other minerals. This type of silica has the advantage of a very low content of impurities, conventionally less than one part per million and typically a few ppb (parts per billion).

The slurry may be produced using techniques known to the person skilled in the art by mixing the metered powders and the required quantity of liquid.

The following procedure is employed to fabricate a sintered silica part by the method of the invention. A mold release agent is applied to the interior face 22 of the permeable portion 12 of the mold 10.

After preparing a slurry according to the invention, the latter is introduced into the mold 10, by gravity, through the top opening 26. For optimum elimination of residual bubbles from the slurry, the container containing the slurry and the molding volume 16 may temporarily and independently be maintained at a lowered pressure, preferably a pressure lowered by more than 0.5 atm.

After filling the molding volume 16, the interior face 22 of the mold 10 that is porous absorbs at least some of the liquid from the slurry. Complete filling of the molding volume 16 and evacuation of the liquid may be encouraged by applying hydrostatic pressure to the interior of the mold 10 using a feeder column of height adapted to the geometry of the part.

When the silica powder conforms closely to the Füller-Bolomey law and contains only particles whose size is from 0.2 μm to 200 μm, the slurry is particularly suited to use in a method including a step of molding under pressure.

As the liquid is evacuated, the particles of amorphous silica are immobilized relative to each other. This immobilization is called drying of the preform. The remaining pores between the immobilized particles nevertheless allow the liquid to pass through and to be absorbed by the outside of the mold 10.

Drying occurs progressively from the porous interior face 22 to the exterior face 32 that is impermeable to the liquid.

Additional slurry is introduced into the mold 10 as the liquid is absorbed. A portion of the volume left vacant by the liquid is thus advantageously filled with particles of silica from the additional slurry.

After this step, the mold 10 contains the preform. The feeding of additional slurry is then stopped end the preform is removed from the mold.

To this end the support 31, which does not adhere to the liner 30, is removed. The preform maintains its geometrical integrity, the liquid having been evacuated. The liner 30 is then removed from the preform, for example by injecting air through the holes 34. This result may equally be achieved by applying traction to the liner 30, or by controlled folding of the liner on itself. The exact method of removing the liner is adapted to suit the geometry of the part.

The blocks 12a-12f are detached and separated from the preform. The presence of the mold release agent on the interior face 22 facilitates removal of the mold. The exterior surface 48 of the crucible not being a “contact” surface, i.e. not in contact with the contents of the crucible in use, its contamination by elements of the permeable portion 12 or by the mold release agent is less important.

After removal from the mold, the preform is dried and then sintered by conventional methods. The preform advantageously has the following characteristics:
bending strength at three points, measured by the test described in the examples, from 2 to 10 MPa;
low content of bubbles or of pores of size greater than 20 μm, as can be seen in FIG. 4, which should be compared with FIG. 3 which shows in section a sample cast with a slurry having a viscosity greater than 30 P that did not allow evacuation of the bubbles trapped in it.

The sintered part has a three-point bending strength from 16 to 30 MPa and a density from 1.6 to 2.2 g/cm³.

Without being bound by any particular theory, the applicant explains the mechanical performance of parts sintered in accordance with the invention in part by the absence of a “divergence front” resulting from a water separation line 50 within the wall 38 (see FIG. 6).

With a conventional two-part permeable plaster mold, the liquid of the slurry initially introduced into the mold, and then of the additional slurry, is aspirated toward the permeable portion of the mold that is closest to it, if the two portions of the mold are equivalent, which is usually the case.

Liquid substantially half-way between the two portions of the molds can therefore be aspirated toward one or the other of those parts. In these areas half-way between the two permeable portions of the mold, forming a divergence front, the sintered part is less dense and therefore more fragile.

This porous area further facilitates corrosion or penetration by liquid silicon. This is why, during conventional molding in a plaster mold, the parameters of the method are adjusted to situate the divergence front at the center of the part in order to limit its negative effects.

According to the invention, the use of a mold having only one permeable portion eliminates said divergence front and produces a part whose density is very homogeneous throughout the whole thickness “e” of the wall.

FIG. 5 shows the calcium content of the wall 38 from the interior surface 46 (“Liner side [Ca] profile”) and from the exterior surface 48 (“Plaster side [Ca] profile”) of the crucible 40. It is found that the calcium content does not increase on approaching the interior surface 46.

This phenomenon is explained by the absence of diffusion or transport of material or ions liable to contaminate the silica from the liner 30 to the slurry contained in the mold 10. The interior surface 46 in contact with the material to be treated in the crucible 40 therefore has the advantage that it is highly pure.

Moreover, the impermeable nature of the liner 30 avoids the liquid transporting impurities coming from the plaster, because the evacuation of the liquid from the slurry is effected exclusively from the preform toward the permeable wall.

Accordingly, at the interior surface 46, the calcium content generated by the diffusion of substances from the plaster mold is more than 50 times less than that measured at the surface in contact with the plaster, and that of sodium is more than ten times less.

It is therefore possible to preserve the purity of the amorphous silica powder initially employed to prepare the slurry. This limited impurity limits contamination of the bath of silicon during use of the crucible and therefore promotes a long life of the charge carriers of wafers cut out from the polycrystalline silicon ingots produced in the crucible 40.

The absence of contamination of the interior surface 46 of the crucible 40 by the mold 10 means that silica parts can be produced that are of very high purity in the vicinity of the interior surface 46.

Each impurity must remain at a level close to that of the initial silica powder; the level of impurities can therefore be maintained in a way that cannot be achieved by the conventional methods of casting in a plaster mold, in particular in respect of the calcium and other substances present in the plaster.

On the other hand, the calcium content conventionally increases on approaching the exterior surface 48. It is therefore preferable for the impermeable portion 14 of the mold 10 to be the portion in contact with the interior surface 46 of the crucible 40.

With plaster molds, a layer of a mold release agent such as graphite, for example, must be disposed between the mold and the slurry to facilitate removal of the preform from the mold.

The liner 30 of the invention is preferably made from a material that does not adhere to the preform, for example silicone. Thus, according to the invention, a mold release agent is no longer required between the liner 30 and the slurry. This has the advantage that the purity of the interior surface 46 of the crucible 40 is increased, all diffusion of mold release agent into the preform being prevented. A further advantage is that this simplifies the fabrication process.

Moreover, with conventional plaster molds, the mold release agent is partially deposited on the surface of the preform. It must therefore be eliminated after removing the preform from the mold, so that a coating material may thereafter be applied to the surface of the part.

The mold release agent is conventionally eliminated by combustion during sintering.

The coating material may be used to create a functional coating after drying. In the case of a crucible intended for the fabrication of polycrystalline silicon, the coating of Si₃N₄ is used as a mold release agent for the silicon, an anti-wetting agent and a diffusion barrier.

According to the invention, no mold release agent being necessary between the slurry and the liner 30, a layer of the coating material may advantageously be applied immediately after the molding step, for example by coating the interior surface 46 of the preform that was in contact with the exterior face 32 of the liner 30. The high mechanical strength of the preform of the invention has the advantage that the coating may be applied without risk of damaging the preform.

The green part and the coating, for example of Si₃N₄ precursor, are advantageously co-sintered. This produces a sintered part that is directly usable, for example for the fabrication of silicon ingots used in the manufacture of solar panels. In this way, a coating having excellent adhesion and remarkable homogeneity is obtained.

The following non-limiting examples are given with the aim of illustrating the invention.

In these examples, the rheological measurements are carried out by the method described above.

The crucibles tested had a substantially square bottom with a side length of more than 500 mm and a side wall substantially perpendicular to the bottom with a substantially constant height greater than 300 mm and a thickness from 5 to 20 mm.

The mechanical strength of the green parts and the sintered parts in bending was measured on samples with dimensions 150 mm×25 mm×25 mm cut out from the parts produced using a Lloyd press and a mount with a distance between centers of 125 mm fitted with a 1000 N or 10 kN sensor.

### EXAMPLE 1

The amorphous silica used in this example was obtained by fusing sand which was then ground in installations reserved for processing highly pure amorphous silica to obtain different particle size range fractions. This source of silica is particularly advantageous as it produces very homogeneous powders of very high purity. The specific surface areas of the powders obtained varied from 0.01 to 20 m²/g.

The following were mixed dry in a mixer:

25% by weight of powder in the particle size fraction 200 μm-620 μm,

50% by weight of powder in the particle size fraction 40 μm-200 μm,

17% by weight of powder in the particle size fraction 1 μm- 40 μm, and

8% by weight of powder in the particle size fraction 0.1 μm-1 μm.

Water was added to obtain a slurry containing more than 87% by weight of dry material. Agitation was maintained to obtain a viscosity from 1 to 30 Poises.

This slurry was cast in a mold as shown in FIG. 1, the side length of the square base of the mold being greater than 700 mm.

The water was then allowed to escape through the plaster exterior portion 12 of the mold for 24 hours.

The central metal support 31 was removed immediately drying was completed.

The flexible liner 30 may be removed at this stage or remain in place during the first part of drying.

The flexible liner 4 was then removed with or without injecting air, according to the sizes and shapes of the required parts. The blocks 12a-12f of the exterior portion 12 of the mold were then removed. At this stage it is possible to move the preform to carry out the final phase of drying and sintering.

The preform obtained had a mechanical strength exceeding 3 MPa. It was dried in an oven at 90° C. for 12 hours and then sintered at 1200° C. for one hour. The finished sintered part had a mechanical strength of 20 MPa. The shrinkage of the preform during sintering was less than 0.5%.

### EXAMPLE 2

The fabrication method was exactly the same as that of example 1, but with the following particle size distribution:

25% by weight of powder in the particle size fraction 200 μm-620 μm,

50% by weight of powder in the particle size fraction 40 μm-200 μm,

15% by weight of powder in the particle size fraction 1 μm-40 μm,

10% by weight of powder in the particle size fraction 0.2 μm-1 μm prepared by the liquid method.

The quantity of water was adjusted so that the slurry contained more than 87% by weight of dry material. The performance was identical to that of example 2, demonstrating the stability of the properties of the parts obtained relative to the grinding methods applied to the powders incorporated in the mixture.

### EXAMPLE 3

The fabrication method was exactly the same as that of example 1, but with the following particle size distribution:

70% to 30% by weight of powder in the particle size fraction 40 μm-200 μm,

50% to 15% by weight of powder in the particle size fraction 1 μm-40 μm,

35% to 5% by weight of powder in the particle size fraction 0.2 μm-1 μm with a specific surface area from 1 to 50 m²/g; this fraction may be obtained by fusing and grinding silica or synthesized by flame hydrolysis of SiCl₄.

The water content was adjusted so that the slurry contained more than 86% by weight of dry material.

This slurry is particularly suited to the pressure casting technique in which water is expelled through a polymer mold by pressure. Two parts were produced from this slurry, one in a mold of the invention and the other in a mold suited to pressure casting. The density of the green parts was from 1.6 to 2 g/cm³.

After sintering, the parts had a cold compressive strength from 80 to 250 MPa, a three-point bending strength from 16 to 30 MPa, and a density from 1.6 to 2.2 g/cm³.

### EXAMPLE 4

The procedure was as in example 1 as far as the drying stage. The interior surface 46 that had been in contact with the silicone liner 30, free of mold release agent, was then coated with an aqueous suspension of Si₃N₄ powder having a mean diameter of 15 μm. The preform and the Si₃N₄ coating were then co-sintered as in example 1 in an oxidizing, neutral or reducing atmosphere. There was obtained in this way a part covered with an adherent coating of Si₃N₄.

### EXAMPLE 5

The slurry was prepared as in example 1, but using a conventional plaster mold (interior and exterior portions of plaster) for the molding process. The wall of the sintered part had, in cross section, a central region that was less dense and porous, also called a “divergence front”, symptomatic of aspiration of water on both sides of the part during molding (from the interior surface 46 and the exterior surface 48).

### EXAMPLE 6

A mixture identical to that of example 1 was prepared, but with the viscosity of the slurry exceeding 30 Poises, the time for the slurry to flow under its own weight through a 23 mm calibrated orifice being greater than 1 minute. The mold filling time becomes very long in this situation and the risk of the slurry ceasing to flow or flowing only with difficulty between the portions of the mold are high. This leads to the formation of incomplete parts, in particular in the comers where the mold may not have been filled correctly.

### EXAMPLE 7

The prepared mixture included a powder having a specific surface area greater than 50 m²/g to constitute the <1 μm fraction. In this case it was necessary to introduce more than 14% by weight of water to disperse the powder, because of the high specific surface area of the <1 μm fraction of the powder and its highly hydrophilic nature. The procedure afterwards was as in example 1. The slurry had a viscosity before casting sufficient to fill the mold, but the drying time was too long. The movement of the slurry inside the mold necessary to evacuate the large quantity of water led to the formation of heterogeneous areas liable to give rise to cracks. Moreover, using powders of very high specific surface area weakens the preform and may contribute to damage thereof during removal of the mold.

The above type of slurry is also not very compatible with the pressure casting or plaster mold casting process. Powders that are too fine are liable to block the pores of the (resin or plaster) molds and to be unfavorable to removal of the mold, with high risks of breakage.

### EXAMPLE 8

The same green materials were used as in example 7, but the slurry was prepared by adding a sufficient quantity of water to obtain a mixture containing 82% by weight of dry material. The viscosity of the slurry before casting was 0.2 Poise. The procedure was as in example 1.

This resulted in sedimentation of the larger grains in the part during casting. They moved under their own weight toward the lower portion of the mold, thereby giving rise to density gradients and therefore to differential shrinkage on drying. Apart from the risk of breakage during drying, the physical, mechanical and thermal properties of the part vary from place to place in this situation.

### EXAMPLE 9

A mixture was prepared containing:

50% by weight of powder in the particle size fraction 200 μm-620 μm,

10% by weight of powder in the particle size fraction 40 μm-200 μm,

30% by weight of powder in the particle size fraction 1μm-40 μm, and

10% by weight of powder in the particle size fraction <1 μm.

It was necessary to introduce 12% by weight of water to disperse the mixture. The viscosity of the slurry was less than 30 Poises but the slurry had an excessively high flow threshold, which prevented it from flowing under its own weight. This type of slurry cannot be used to cast parts without strong vibration of the mold to move the slurry into place. This technique is therefore not suitable for casting large thin parts in a plaster mold.

The above examples make it clear that it is preferable to use a slurry of the Invention in the method of the invention to obtain highly compacted parts whose contact surface is free of contamination, that are easy to remove from the mold and have good mechanical properties. As is now clearly apparent, the method of the invention can be used to fabricate sintered silica parts with large dimensions, of any shape, of low porosity, and substantially without shrinkage during drying of the preform. The method of the invention is also simpler than the prior art methods.

Of course, the present invention is not limited to the embodiments described and shown by way of illustrative and nonlimiting examples.

1.-33. (canceled)

34. Mold (10) for fabricating a silica-based preform intended to be sintered, adapted to receive a slurry based on amorphous silica powder and a liquid, having an interior portion (14) and an exterior portion (12) adapted to delimit a wall (38) of said preform, at least in an area delimiting a usable portion of said wall (38), only one of said interior portion (14) and exterior portion (12), called the “permeable portion” (14), being permeable to said liquid, wherein in at least one area delimiting a usable portion of said wall at least one of said interior and exterior portions is deformable.

35. Mold according to claim 34, wherein, in said area, the distance between said interior portion (14) and said exterior portion (12) is substantially constant.

36. Mold according to claim 35, wherein, in said area, the distance between said interior portion (14) and said exterior portion (12) is less than 10 cm, preferably less than 5 cm.

37. Mold according to claim 34, wherein said permeable portion (12) is made of a material absorbing said liquid in a similar manner to plaster.

38. Mold according to claim 34, wherein said portion that is not permeable to said liquid, called the “impermeable portion” (14), includes a liner (30) deformable as a result of a modification of the dimensions of said preform during its fabrication.

39. Mold according to claim 38, wherein said liner (30) is conformed to be removed or “peeled” toward the interior of said preform avoiding all contact with said preform.

40. Mold according to claim 38 wherein said liner (30) is sufficiently deformable to allow forcible passage of a protuberance of said preform having a height less than or equal to 1.1 times the thickness of said liner (30) during the removal of said preform from the mold.

41. Mold according to claim 38, wherein said liner (30) is made of a material that is inert with respect to said slurry.

42. Mold according to claim 40, wherein said liner does not adhere to said preform or may be unstuck from said preform by deformation of said liner (30) during removal from the mold.

43. Mold according to claim 38, wherein said liner (30) is made of silicone or a cellular material.

44. Mold according to claim 38, wherein said liner (30) includes air injection holes (34).

45. Mold according to claim 38, wherein said impermeable portion (14) includes a support (31) of said liner (30).

46. Method of fabricating a sintered silica part, comprising the following steps:
a) casting a slurry based on amorphous silica powder and a liquid between an interior portion (14) and an exterior portion (12) of a mold (10) according to claim 34 to delimit a wall (38) of said part (40),
b) at least partially evacuating said liquid to obtain a preform,
c) removing said preform from the mold to obtain a green part,
d) further drying said green part,
e) sintering said green part,
wherein, in the step b), in at least one area delimiting a usable portion of said wall (38), said liquid is evacuated through one only of said interior portion (14) and said exterior portion (12) of said mold (10), called the “permeable portion” (12), the other portion being called the “impermeable portion” (14).

47. Method according to claim 46, wherein, prior to the step e), a coating material is applied to said green part.

48. Method according to claim 47, wherein said coating material is a precursor of silicon nitride (Si₃N₄).

49. Method according to claim 46, wherein, during the step b), feeding of said mold (10) with slurry continues to compensate the evacuation of said liquid.

50. Method according to claim 46, wherein, during the step b), to encourage the elimination of bubbles in said slurry, a reduced pressure is maintained in the container that contains the slurry before casting and/or independently in said mold.

51. Method according to claim 46, wherein, said mold (10), during the step c) of removal of the mold, said support (31) and said liner (30) are separated from said preform independently of each other.

52. Method according to claim 46, wherein said slurry contains a powder based on amorphous silica mixed with a solvent, the particle size range of said powder conforming to the Füller-Bolomey law.

53. Method according to claim 52, wherein said powder contains a mixture of at least two amorphous silica powders.

54. Method according to claim 52, wherein said powder contains only particles whose size is from 0.1 to 620 μm.

55. Method according to claim 52, wherein said powder includes only particles whose size is from 0.2 to 200 μm.

56. Method according to claim 52, wherein said slurry contains more than 85% of dry material.

57. Method according to claim 52, wherein said slurry has a viscosity from 1 to 30 Poises at the beginning of the casting step a).

58. Method according to claim 52, wherein the dry fraction of said slurry contains more than 99.5% silica.

59. Method according to claim 52, wherein said silica powder has a specific surface area from 0.01 to 20 m²/g.

60. Method according to claim 52, wherein said liquid is water.

61. Method according to claim 52, wherein it includes a step of casting under pressure.

62. Green part fabricated by the steps a) to c) of a method according to claim 46 and therefore having no divergence front, which has a three-point bending strength from 2 to 10 MPa.

63. Green part according to claim 62, which has a density greater than 1.9 g/cm³.

64. Sintered silica part fabricated by a method according to claim 46, which has a three-point bending strength from 16 to 30 MPa.

65. Sintered silica part according to claim 64, which has a density from 1.6 to 2.2 g/cm³.

66. Crucible (40) to fabricate polycrystalline silicon ingots comprising a sintered silica part according to claim 64.
